(19) United States
(12) Patent Application Publication
(10) Pub. No.: US 2007/0263145 A1
(43) Pub. Date: Nov. 15, 2007

(54) LIQUID CRYSTAL DISPLAY DEVICE

(75) Inventors: Yoshimitsu Ishikawa, Tokyo (JP); Yasuhiro Morii, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/745,810

(22) Filed: May 8, 2007

(30) Foreign Application Priority Data
May 15, 2006 (JP) 2006-135276

(51) Int. Cl. G02F 1/1335

(52) U.S. Cl. 349/114

(57) ABSTRACT

A liquid crystal display device according to an embodiment of the invention includes: a transmissive region and a reflective region in one pixel; a TFT substrate; a CF substrate; a liquid crystal layer formed between the TFT substrate and the CF substrate; a first polarization control element provided on the side opposite to the liquid crystal layer of the TFT substrate; and a second polarization control element provided on the side opposite to the liquid crystal layer of the CF substrate. The first polarization control element and the second polarization control element each include at least a polarizing plate and a retarder. The second polarization control element includes a liquid crystal film as a retarder, the second polarization control element is provided closer to a display surface side than the first polarization control element, and an antireflection film is formed on the second polarization control element.

### BACKGROUND OF THE INVENTION

1. Field of the Invention

The present invention belongs to the field of liquid crystal display device, and more particularly relates to a liquid crystal display device including a reflective region and a transmissive region.

2. Description of Related Art

Liquid crystal panels are roughly classified into three display types of a transmissive type, a reflective type, and a transflective type. A transmissive type panel turns on light called “back light” to display an image by use of light transmitted through the liquid crystal panel and thus has high scotopic visibility but has low photopic visibility. On the other hand, a reflective type panel displays an image by use of light incident on and reflected by the liquid crystal panel and thus has high photopic visibility but has low scotopic visibility. A so-called transflective type panel having both functions of the transmissive type and reflective type switches a display mode in accordance with ambient brightness to thereby realize a display of high visibility all the time. Thus, the transflective type liquid crystal panel has been widely used for a cell-phone or mobile-device display.

In particular, in a transflective type liquid crystal panel including a region where an image is displayed in a transmissive mode (transmissive region) and a region where an image is displayed in a reflective mode (reflective region), which are separately formed in one pixel, relatively high display characteristics are obtained with the following structure. That is, circularly polarizing plates are arranged on both sides of a panel, and a liquid crystal layer thickness is set for each of the reflective region and the transmissive region such that the product of the liquid crystal layer thickness (d) and liquid-crystal refractive index anisotropy (Δn) of the reflective region equals about ¼-wavelength, and the product of the liquid crystal layer thickness (d) and liquid crystal refractive index anisotropy (Δn) of the transmissive region equals about ½-wavelength. Thus, either in the reflective mode or transmissive mode, an image can be displayed in a normally white mode (display mode for applying a voltage to the liquid crystal layer to turn a screen black).

In general, the circularly polarizing plate is completed by combining a polarizing plate, a ¼-wavelength plate (λ/4-wave plate), and a ½-wavelength plate (λ/2-wave plate). Optical characteristics thereof include wavelength dependency (wavelength dispersion). The wavelength dispersion is controlled by appropriately selecting a combination thereof to thereby obtain higher display characteristics.

Some of recent transflective type liquid crystal panels employ a viewing angle compensation film as the λ/4-wave plate of the circularly polarizing plate to improve viewing angle characteristics. To be specific, a transflective type liquid crystal display device using a retardation film (NH film) obtained by hybrid-aligning rod-like polymer liquid crystals available from ENEOS is disclosed (Japanese Unexamined Patent Application Publication No. 2004-341207). Further, a transflective type liquid crystal display device using a film obtained by hybrid-aligning discotic liquid crystal compounds available from FUJIFILM Corporation (Wide Viewing film: WV film) is disclosed (Japanese Unexamined Patent Application Publication No. 2005-107501). Japanese Unexamined Patent Application Publication Nos. 2004-341207 and 2005-107501 describe the liquid crystal display device using a hybrid-aligned liquid crystal film. In the device disclosed in Japanese Unexamined Patent Application Publication No. 2004-341207, the NH film itself serves as a λ/4-wave plate. In contrast, in the device disclosed in Japanese Unexamined Patent Application Publication No. 2005-107501, the WV film and an additional retardation film constitute a λ/4-wave plate.

Further, many reflective or transflective type liquid crystal panels are subjected to antireflection (AR) processing for lowering reflectivity on the liquid crystal panel surface in order to realize high-contrast display even in bright light.

The AR processing is realized with multilayered thin films of different reflective indexes. Light reflected by the surface is canceled out by interference. As conceivable examples of the thin film formation method, there are wet-coating, vacuum-deposition, and continuous sputtering, each of which has advantages and disadvantages. As a general rule, AR processing costs high, so how to save costs has been under study.

The reflective or transflective type liquid crystal display device reflects and diffuses light incident on the liquid crystal panel to thereby increase visibility in a reflective mode. As another method of reflecting and diffusing incident light, a reflective electrode is made uneven in section to thereby perform reflection and diffusion at the same time. As still another method, reflection and diffusion are separately performed.

As an example of this method, a dispersion adhesive is applied onto the polarizing plate on the CF (color filter) substrate side. The dispersion adhesive bonds the CF substrate side polarizing plate (a laminate of polarizer and retarder) to a glass substrate. Alternatively, retarders in the CF substrate side polarizing plate are bonded together. Further, the dispersion adhesive is obtained by randomly mixing beads of different reflective indexes into an adhesive. The dispersion adhesive has a function of diffusing transmitted light.

Further, the liquid crystal panel includes a mirror reflector or a mirror reflective electrode. External light is reflected by the mirror reflector or the mirror reflective electrode. The reflected light is diffused while transmitted through the dispersion adhesive. The adhesive having no diffusion function is replaced by a dispersion adhesive to improve visibility in a reflective mode.

The method of performing reflection and diffusion at the same time and the method of performing reflection and diffusion separately can diffuse light in all directions even if light is incident in one direction. The visibility in a reflective mode can be improved.

A transflective type liquid crystal panel of a normally white mode (display mode for applying a voltage to the liquid crystal layer to turn a screen black) turns a screen black in a transmissive mode and a reflective mode by adjusting a phase difference of the circularly polarizing plate and a phase difference of liquid crystal to a predetermined value. The phase difference is adjusted to a predetermined value by arranging circularly polarizing plates on both sides of the liquid crystal panel and setting a liquid crystal layer thickness for each of the reflective region and the transmissive region. A liquid crystal phase difference is changed by applying a voltage to liquid crystal to change aligned conditions of liquid crystal. If a phase difference of the circularly polarizing plate deviates from a predetermined value and a preset voltage for turning a screen black is applied, the optimum black display cannot be obtained, and black display quality is lowered.

Thus, a phase difference of the retarder as the liquid crystal film in the circularly polarizing plate should be controlled with high accuracy. However, in conventional liquid crystal display devices that use a WV film as a retarder, under high humidity or temperature conditions, a voltage for turning a screen black is changed. This is because an in-plane phase difference of discotic liquid crystal of the WV film or TAC (triacetyl cellulose) as a base film on which a liquid crystal layer is formed is changed. TAC or the liquid crystal for forming the liquid crystal film is thermally expanded at a given temperature and takes up moisture at a given humidity. This causes change in stress. As a result, a phase change is greater than a change in a general retarder. If a phase difference is changed this way, the screen cannot be turned initial black at an initial preset voltage for turning a screen black. As a result, a contrast ratio is lowered to decrease display quality.

### SUMMARY OF THE INVENTION

The present invention has been accomplished with a view to solving the above problems, and aims at providing a liquid crystal display device capable of preventing deterioration in display characteristics without increasing costs.

A liquid crystal display device according to an aspect of the present invention includes: a transmissive region and a reflective region formed in one pixel; a first substrate; a second substrate provided closer to a display surface than the first substrate and opposite to the first substrate; a liquid crystal layer formed between the first substrate and the second substrate; a first polarization control element provided on a side opposite to the liquid crystal layer of the first substrate and including a polarizing plate and a retarder; a second polarization control element provided on a side opposite to the liquid crystal layer of the second substrate and including a polarizing plate and a retarder, the retarder provided in the second polarization control element consists of a liquid crystal film; and an antireflection film formed on the second polarization control element.

According to the present invention, it is possible to provide a liquid crystal display device capable of preventing display characteristics from deteriorating.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a diagram of a pixel in a TFT substrate;

FIGS. 2A to 2E are side sectional views of the TFT substrate in each step of a TFT substrate manufacturing process;

FIG. 3 is a sectional view of a transflective type liquid crystal panel according to a first embodiment of the present invention;

FIG. 4 is a sectional view of a general transflective type liquid crystal panel as a reference example;

FIG. 5 is a sectional view of a general transflective type liquid crystal panel as a reference example;

FIG. 6 is a sectional view of a transflective type liquid crystal panel according to a second embodiment of the present invention;

FIG. 7 is a sectional view of a transflective type liquid crystal panel according to a third embodiment of the present invention; and

FIG. 8 is a sectional view of a transflective type liquid crystal panel according to a fourth embodiment of the present invention.

### DESCRIPTION OF THE PREFERRED EMBODIMENTS

Prior to description of the embodiments, common structure and method, that is, structure and manufacturing method of a liquid crystal panel is described.

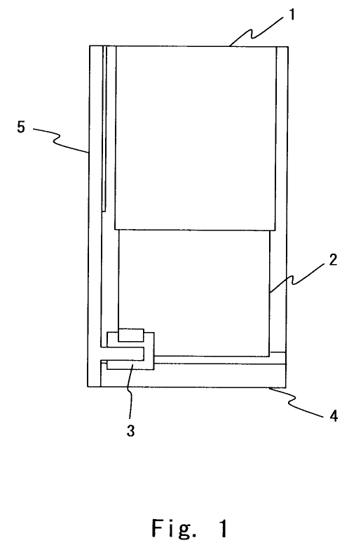

FIG. 1 is a diagram of a pixel in a TFT substrate used in the present invention.

In the TFT substrate, each pixel includes a transmissive electrode (transparent electrode) 1 corresponding to a transmissive region and a reflective electrode 2 corresponding to a reflective region. A region including the transmissive electrode 1 (transmissive region) transmits light from a backlight unit and a region including the reflective electrode 2 (reflective region) reflects external light. Then, to drive a pixel electrode composed of the transmissive electrode 1 and the reflective electrode 2, each pixel includes a TFT (thin film transistor) 3. Then, a drain electrode of the TFT 3 is electrically connected with the transmissive electrode 1 and the reflective electrode 2. The gate electrode of the TFT 3 is connected with a gate line (scanning line) 4 to execute on/off control over the TFT 3 based on a signal input from the gate terminal. A source electrode of the TFT 3 is connected with a source line (signal line) 5. If a voltage is applied to the gate electrode, a current flows thorough the source line 5. A voltage applied to the source electrode is appropriately controlled to thereby change actual voltage applied to liquid crystal (driving voltage). The voltage applied to liquid crystal can be adjusted with the source electrode. Thus, as for driving conditions of liquid crystal, an intermediate transmittance of liquid crystal can be freely determined.

The present invention is not only applied to such simple structure that the transmissive region and the reflective region are upper and lower regions of a pixel like the TFT substrate as shown in FIG. 1 but also the structure where the transmissive region and the reflective region are arbitrarily defined. Further, the present invention is applicable irrespective of sectional structure of the TFT 3.

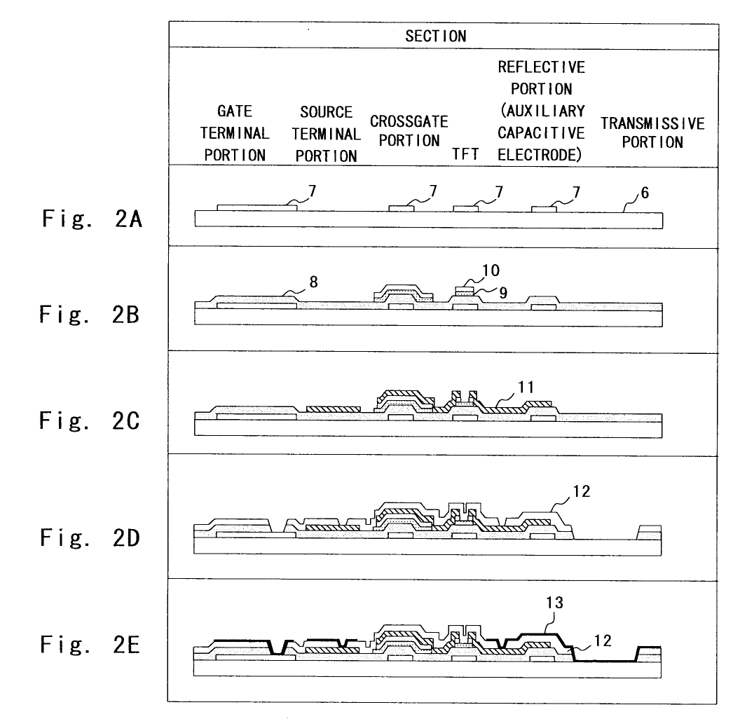

Next, a manufacturing process of the liquid crystal panel is described. Referring first to FIGS. 2A to 2E, a manufacturing process of the TFT substrate is described. First, a gate line, a gate electrode, and a gate terminal are formed. A metal thin film 7 is formed on a transparent substrate 6 made of glass or the like through sputtering. Then, a photoengraving process is executed such that a resist as a photosensitive resin is applied onto the metal thin film 7 through spin-coating, and the applied resist is subjected to exposure and development. After that, the metal thin film 7 is patterned through etching to thereby form a gate line, a gate electrode, and a gate terminal. After this process, as shown in FIG. 2A, patterns of the metal thin film 7 are formed on the transparent substrate 6.

Subsequently, an insulating film 8, a semiconductor thin film 9, and an ohmic contact film 10 are successively formed by various CVD methods such as a plasma CVD method, and patterns of the semiconductor thin film 9, and the ohmic contact film 10 are formed through a photoengraving process and an etching process. The insulating film 8 is made of SiNₓ or SiO_{y} and used as a gate insulating film. As the semiconductor thin film 9, for example, amorphous silicon (a-Si) or polysilicon (p-Si) is used. The ohmic contact film 10 is an n type semiconductor, and an n-a-Si film or n-p-Si film obtained by doping a small amount of phosphorus (P) into a-Si or p-Si is used as the ohmic contact film 10. As a result, the structure of FIG. 2B is obtained.

After that, a conductive film 11 is formed through sputtering, which is used for forming a source line, and then a photoengraving process and an etching process are performed. As a result, a source line, a source electrode, a drain electrode, a reflective electrode, and a source terminal are formed. The patterns of the source line, the source electrode, the drain electrode, the reflective electrode, and the source terminal are used as a mask, and the underlying ohmic contact film 10 is removed through etching. It is desirable to insulate adjacent source lines from each other. A central portion of the ohmic contact film 10 in the TFT portion is removed by this process to expose the semiconductor thin film 9. Through the above processes, the structure of FIG. 2C is formed on the substrate.

After that, a protective film 12 is formed with an insulating film made of Si₃N₄, SiO₂, etc., or mixture or laminate thereof, by various CVD methods such as plasma CVD. To ensure continuity with the gate terminal and the source terminal, a contact hole is formed in the insulating film 8 and the protective film 12. At this time, a contact hole is formed also in the protective film 12 to obtain continuity with the drain electrode of the TFT. As a result, the structure of FIG. 2D is obtained.

After that, a transparent conductive film 13 is formed of ITO (Indium Tin Oxide), SnO₂, InZnO, etc. through sputtering, evaporation, coating, CVD, printing, and a sol-gel method. The transparent conductive film 13 may be a transparent conductive layer made of a mixture or laminate of these materials. Then, a transmissive electrode is formed through a photoengraving process and an etching process. As a result, the structure of FIG. 2E is obtained. The transmissive electrode and the reflective electrode are electrically connected with the drain electrode. Through these series of steps, the TFT substrate for driving liquid crystal is completed.

Next, an assembly step of the liquid crystal panel composed of the thus-manufactured TFT substrate and CF substrate opposite thereto is described. The two substrates are coated with a polyimide resin, for example, AL-22501 available from JSR as an oriented film for aligning liquid crystal molecules, followed by rubbing with cloth. The rubbing direction of the TFT substrate is opposite and parallel to the rubbing direction of the CF substrate, and liquid crystal is parallel-aligned to the TFT substrate and CF substrate. A sealing material is applied around a display region on the TFT substrate with a dispenser, and the substrates are bonded such that the oriented films face each other. At this time, a spacer may be sprayed between the TFT substrate and the CF substrate. The sealing member is cured while heated under an appropriate pressure. A cell gap of the transmissive region is adjusted to 3.8 μm, and a cell gap of the reflective region is adjusted to 2.0 μm. Then, a liquid crystal material having a double refractive index of 0.065 to 0.070, for example, MJ042545 available from melc is filled in between the substrates with vacuum infusion or the like. After the injection of the liquid crystal, an injection port is sealed to complete the liquid crystal panel.

A circularly polarizing plate with a retarder as described in detail in the following embodiments is bonded to the outer surface of the thus-manufactured liquid crystal panel on both of the TFT substrate side and CF substrate side. Further, a back light unit as an illuminating device is provided outside the TFT substrate to complete the liquid crystal display device. The transmissive region transmits light from a back light unit. In the reflective region, external light incident on the liquid crystal panel is reflected by reflective electrode. As a result, the incident external light can be reflected to the display surface side.

### First Embodiment

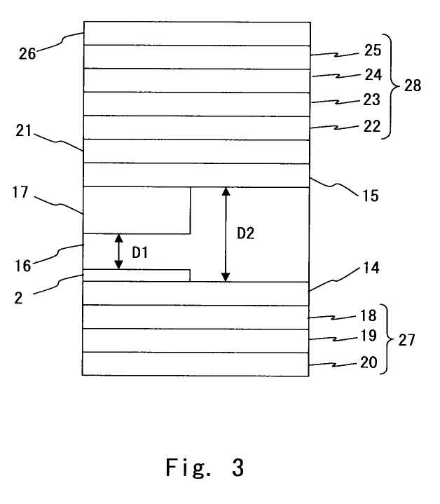

FIG. 3 is a sectional view of the structure of a transflective type liquid crystal panel according to a first embodiment of the present invention. A liquid crystal layer 16 is formed between a first substrate (for example, a TFT substrate 14 of this embodiment) and a second substrate (for example, a CF substrate 15 of this embodiment), which are opposite to each other. Further, a liquid crystal panel includes a first polarization control element 27 provided to the TFT substrate 14 on the opposite side of the liquid crystal layer 16 and a second polarization control element 28 provided to the CF substrate 15 on the opposite side of the liquid crystal layer 16. Further, an antireflection film 26 is provided on the opposite side of the CF substrate 15 of the second polarization control element 28.

The first polarization control element 27 and the second polarization control element 28 each include at least a polarizing plate and a retarder. The polarizing plate absorbs light oscillating in one direction and allows transmission of light oscillating in the other direction to thereby generate linearly-polarized light. In this embodiment, a first polarizer 20 and a second polarizer 25 constitute the polarizing plate. The retarder involves a special phase difference of λ/2 or λ/4. The retarder of the phase difference of λ/2 or λ/4 is referred to as λ/2-wave plate or λ/4-wave plate. The retarder is used for optical compensation and used for widening a viewing angle.

The second polarization control element 28 is provided on the display surface side of the CF substrate 15. The second polarization control element 28 includes a second polarizer 25, a second λ/2-plate 24, a biaxial retarder 23, and a liquid crystal film 22 in this order from the display surface side to constitute the circularly polarizing plate. Accordingly, incident external light is linearly polarized by the second polarizer 25. Further, light is circularly polarized by the second λ/2-plate 24, the biaxial retarder 23, and the liquid crystal film 22 and then incident on the CF substrate 15. Further, the second polarization control element 28 and the CF substrate 15 are bonded with a light diffusion layer 21.

On the other hand, a first polarization control element 27 is provided on the rear side of the TFT substrate 14. The first polarization control element 27 includes a first polarizer 20, a first λ/2-plate 19, and a first λ/4-wave plate 18 in this order from the rear surface side to constitute the circularly polarizing plate. Accordingly, light from a back light unit is linearly polarized by the first polarizer 20. Further, the light is circularly polarized by a first λ/2-plate 19 and a first λ/4-wave plate 18 and incident on the TFT substrate 14.

The circularly polarizing plate is a so-called wide-band circularly polarizing plate composed of a laminate of a λ/4-wave plate, a λ/2-plate, and a polarizing plate. The wide-band circularly polarizing plate is intended to convert incident light into circularly polarized light to widen a selective wavelength band. The first λ/4-wave plate 18 may be a biaxial retarder and designed to further wide viewing angle. At this time, Nz coefficient of the biaxial retarder is desirably 0 to 0.8. Nz coefficient is defined as follows: Nz=(nx−nz)/(nx−ny). In this case, a refractive index in a slow axis direction in the retarder plane is represented by nx, a refractive index in a direction vertical to nx in the retarder plane is represented by ny, and a refractive index in a vertical direction of the retarder is represented by nz. A parameter for controlling polarized conditions of light emitted in the forward direction of the retarder is a phase difference and slow axis angle in the retarder plane, and absorbing axis angle of the polarizing plate.

In this embodiment, the reflective region includes a liquid crystal layer 16, a reflective electrode 2, and a gap control layer 17. Incidentally, the other components such as an oriented film and a color filter are not shown. In this embodiment, the reflective electrode 2 is partially formed on the TFT substrate 14, and a gap control layer 17 is partially formed below the CF substrate 15. Further, the reflective electrode 2 and the gap control layer 17 face each other. Light incident from the CF substrate 15 side is reflected by the reflective electrode 2.

In a transflective type liquid crystal display device using the circularly polarizing plate, a cell gap should be set for each of the transmissive region and the reflective region. That is, the gap control layer 17 is formed to adjust a cell gap D2 in the transmissive region and a cell gap D1 in the reflective region. The gap control layer 17 for defining a cell gap may be formed on the TFT substrate 14 side or the CF substrate 15 side. Needless to say, the gap control layer 17 may be formed on both of the TFT substrate 14 side and the CF substrate 15 side. In this embodiment, a description is made of the structure that the gap control layer 17 is formed on the CF substrate 15 side. Further, a liquid crystal material for the liquid crystal layer 16 is uniaxially aligned substantially in parallel to the TFT substrate 14 and the CF substrate 15 if not applied with a voltage, or moved to rise if applied with a voltage.

A light diffusion layer 21 is formed between the CF substrate 15 and the second polarization control element 28. In this embodiment, for example, a dispersion adhesive is used for the light diffusion layer 21. This is because beads of different refractive indexes are randomly mixed into an adhesive material to impart a diffusion function. If the haze value of the dispersion adhesive is 60 or more, reflected light can be well diffused.

In this embodiment, the liquid crystal film 22 is a WV film available from FUJIFILM Corporation. The liquid crystal film 22 is used as a part of the λ/4-wave plate or λ/4-wave plate and as a viewing angle compensation film. The WV film is a liquid crystal film obtained by hybrid-aligning discotic liquid crystal compounds. Further, the biaxial retarder 23 is POLYCA available from Nitto Denko Corporation (in-plane phase difference=140 nm, Nz coefficient=0.1), and a first λ/4-wave plate 18, a first λ/2-plate 19, and a second λ/2-plate 24 are each ZEONOR available from Nitto Denko Corporation. These are bonded each other with an adhesive. The antireflection film 26 is, for example, AR3 available from Sony Chemical&Information Device Corporation. Further, the antireflection film 26 of a laminate film structure formed through continuous sputtering (a film of large refractive index and a film of small refractive index are alternately layered) produces a greater effect than the film of a single-layer.

A liquid crystal display device that uses the WV film as a retarder changes a phase difference under high-humidity or -temperature conditions, and the optimum black display voltage is changed. As a result, there arises a problem that a contrast ratio is lowered. Here, in this embodiment, the second polarization control element 28 subjected to antireflection (AR processing) through continuous sputtering is provided on the display surface side of the transflective type liquid crystal display device. As a result, change in optimum black display voltage is suppressed under high-humidity or -temperature conditions. Thus, reduction in contrast ratio can be suppressed down to 1/10 or less of that of the polarization control element not subjected to antireflection (AR processing).

As for the antireflection (AR processing), multilayered thin films of different refractive indexes are formed, and light reflected by the surface is canceled out by interference. Antireflection is processed by providing the antireflection film 26. The antireflection (AR processing) is applied only to the second polarization control element 28 on the CF substrate 15 side. That is, the antireflection film 26 is formed on the display surface side of the liquid crystal panel. In the related art of Japanese Unexamined Patent Application Publication No. 2005-107501, a WV film is formed on the TFT substrate side. In such structure, the TFT substrate side surface should be subjected to antireflection (AR processing) to suppress a phase difference change under high-humidity or -temperature conditions. This leads to a remarkable increase in cost. Thus, in this embodiment, the second polarization control element 28 including the liquid crystal film 22 is formed on the CF substrate 15 side. Then, the antireflection film 26 is formed through continuous sputtering on the second polarization control element 28 on the CF substrate 15 side. Hence, it is possible to prevent a contrast ratio from lowering even under high-humidity or -temperature conditions without increasing costs. That is, according to this embodiment, deterioration in display characteristics can be prevented.

Further, in this embodiment, the light diffusion layer 21 is used. It is best to form the light diffusion layer 21 between the second polarization control element 28 and the CF substrate 15, that is, between the liquid crystal film 22 and the CF substrate 15. This is because, if the light diffusion layer 21 is formed in the other portion, for example, between the liquid crystal film 22 and the biaxial retarder 23, between the biaxial retarder 23 and the second λ/2-plate 24, and between the second λ/2-plate 24 and the second polarizer 25, light reflected by the light diffusion layer 21 increases reflective luminance in black display.

The rate that the reflective luminance is increased in black display becomes large as the distance of the light diffusion layer 21 from the CF substrate 15 increases. This is because design values of the retarder (liquid crystal film 22, biaxial retarder 23, and second λ/2-plate 24) provided on the CF substrate 15 side are determined such that blackest black is obtained with respect to light reflected by the reflective electrode 2 in the liquid crystal cell. Light reflected by a portion other than the reflective electrode 2 is not considered. Hence, light reflected by a portion other than the reflective electrode 2 is transmitted through the second polarizer 25.

For example, if the light diffusion layer 21 is formed between the liquid crystal film 22 and the biaxial retarder 23, there is reflected light for which a residual phase difference in the liquid crystal layer 16 and the phase difference in the liquid crystal film 22 are not considered. Accordingly, the reflected light is partially transmitted through the second polarizer 25. As a result, a contrast ratio is lowered in a reflective mode. Further, if the light diffusion layer 21 is formed between the biaxial retarder 23 and the second λ/2-plate 24, there is a reflected light for which a residual phase difference in the liquid crystal layer 16, a phase difference in liquid crystal film 22, and a phase difference in biaxial retarder 23 are not considered. Thus, a contrast ratio is lower in the reflective mode. Here, if the light diffusion layer 21 is formed between the CF substrate 15 and the liquid crystal film 22, only a residual phase difference in the liquid crystal layer 16 is not considered. Therefore, it is possible to prevent a contrast ratio from lowering. Hence, it is best to form the light diffusion layer 21 between the CF substrate 15 and the second polarization control element 28, that is, between the CF substrate 15 and the liquid crystal film 22.

The display characteristics of the liquid crystal panel are determined by a phase difference and slow axis angle of various retarders of the first polarization control element 27 and the second polarization control element 28 (first λ/4-wave plate 18, first λ/2-plate 19, liquid crystal film 22, biaxial retarder 23, and second λ/2-plate 24), absorbing axis angle of the polarizing plate, a phase difference and slow axis angle of the liquid crystal film 22, a cell gap of each of the reflective region and the transmissive region, twist angle (angular difference in rubbing direction between the TFT substrate 14 and the CF substrate 15) of the liquid crystal layer 16, and physical properties of a liquid crystal material (refractive index). Desired electrooptical characteristics can be obtained with these parameters. Values of the above parameters that contribute to optical design of this embodiment are summarized in Table 1. The retardation of the retarder or a refractive index of a liquid crystal material is calculated based on the wavelength of 550 nm.

TABLE 1

| | | in-plane phase | slow axis or |
|---|---|---|---|
| | | difference | absorbing axis |
| CF | second polarizer 25 | — | 164° |
| substrate | second λ/2-wave | 225 nm | 155° |
| 15 side | plate 24 | | |
| | biaxial retarder 23 | 140 nm, Nz = 0.1 | 107° |
| | liquid crystal film | 32 nm | 289° |
| | 22 | | |
| liquid crystal (transmissive) | | 254 nm | 270° |
| liquid crystal (reflective) | | 134 nm | 270° |
| TFT | first λ/4-wave | 110 nm | 106° |
| substrate | plate 18 | | |
| 14 side | first λ/2-wave | 260 nm | 33° |
| | plate 19 | | |
| | first polarizer 20 | — | 98° |

As for the axial angle, the 3 o'clock direction is set to 0°, the 12 o'clock direction is set to 90°, the 9 o'clock direction is set to 180°, and the 6 o'clock direction is set to 270°.

In the case where the structures of the first polarization control element 27 and the second polarization control element 28, and design values of Table 1 are used, under high-humidity or -temperature conditions, the optimum black display voltage is not changed, and a contrast ratio is not lowered.

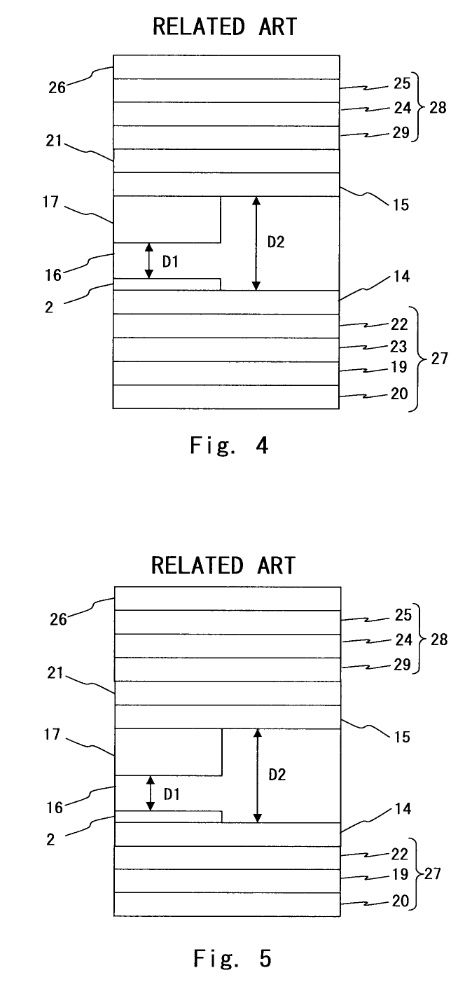

As described above, high display quality is obtained in this embodiment as compared with general transflective liquid crystal panels as shown in FIG. 4 or FIG. 5. In the general transflective liquid crystal panels as shown in FIG. 4 or FIG. 5, the liquid crystal film 22 is formed on the back light unit side (opposite of the display surface side). Then, the antireflection film 26 is not formed on the liquid crystal film 22 side but on the display surface side alone. Therefore, a phase difference of the liquid crystal film 22 is changed under high-humidity or -temperature conditions. Thus, the optimum black display voltage is changed, and a contrast ratio is lowered. In this embodiment, the liquid crystal film 22 is formed on the display surface side where the antireflection film 26 is formed. Thus, a phase difference of the liquid crystal film 22 is not changed, and a liquid crystal display device of higher display quality is obtained under high-humidity or -temperature conditions.

In this embodiment, the light diffusion layer 21 is inserted between the second polarization control element 28 (a laminate of the second polarizer 25, the second λ/2-plate 24, the biaxial retarder 23, and the liquid crystal film 22) and the liquid crystal panel. That is, the light diffusion layer 21 is used as an adhesive for bonding the second polarization control element 28 to the glass substrate of the CF substrate 15. As a result, light reflected by the reflective electrode 2 in the liquid crystal panel can be diffused with the light diffusion layer 21. Further, as described above, the antireflection film 26 is formed on the second polarizer 25 to prevent a phase difference of the liquid crystal film 22 from changing under high-humidity or -temperature conditions. A reflective liquid crystal display device or transflective liquid crystal display device of this type enables high display quality in a reflective mode without decreasing a contrast ratio in a transmissive mode.

### Second Embodiment

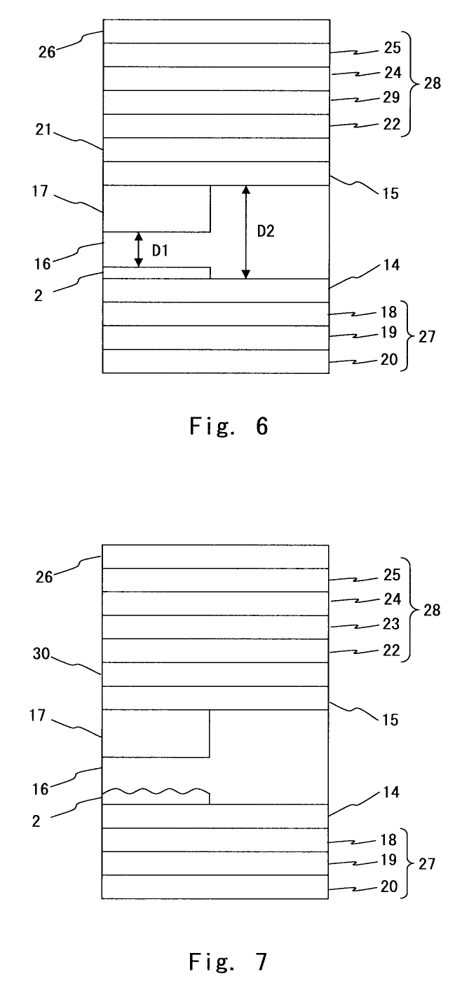

FIG. 6 is a sectional view of the structure of a transflective type liquid crystal panel according to a second embodiment of the present invention. In the transflective type liquid crystal panel, a second λ/4-wave plate 29 as a uniaxial retarder is used as the biaxial retarder 23 of the first embodiment. That is, the second λ/4-wave plate 29 is provided between the liquid crystal film 22 and the second λ/2-plate 24. Further, the second λ/4-wave plate 29 is ZEONOR available from Nitto Denko Corporation. Values of parameters that determine optical design of the second embodiment are summarized in Table 2.

TABLE 2

| | | in-plane phase | slow axis or |
|---|---|---|---|
| | | difference | absorbing axis |
| CF | second polarizer 25 | — | 164° |
| substrate | second λ/2-wave | 225 nm | 155° |
| 15 side | plate 24 | | |
| | second λ/4-wave | 140 nm | 107° |
| | plate 29 | | |
| | liquid crystal film | 32 nm | 289° |
| | 22 | | |
| liquid crystal (transmissive) | | 254 nm | 270° |
| liquid crystal (reflective) | | 134 nm | 270° |
| TFT | first λ/4-wave | 110 nm | 106° |
| substrate | plate 18 | | |
| 14 side | first λ/2-wave | 260 nm | 33° |
| | plate 19 | | |
| | first polarizer 20 | — | 98° |

As for the axial angle, the 3 o'clock direction is set to 0°, the 12 o'clock direction is set to 90°, the 9 o'clock direction is set to 180°, and the 6 o'clock direction is set to 270°.

In this embodiment as well, it is best to form the light diffusion layer 21 between the liquid crystal film 22 and the CF substrate 15 for the same reason as the first embodiment.

In this embodiment, a viewing angle is not wider than that of the first embodiment but a cost is saved since the uniaxial retarder is used in place of the biaxial retarder. Further, the transflective type liquid crystal display device of this embodiment enables high display quality in a reflective mode without changing the optimum black display voltage and reducing a contrast ratio under high-humidity or -temperature conditions.

As described in this embodiment, the biaxial retarder 23 of the second polarization control element 28 may be the second λ/4-wave plate 29. Further, the biaxial retarder 23 may be used for one or both of the first polarization control element 27 and the second polarization control element 28.

### Third Embodiment

FIG. 7 is a sectional view of the structure of a transflective liquid crystal panel according to a third embodiment of the present invention. In this embodiment, an adhesive 30 is used in place of the light diffusion layer 21 of the first and second embodiments. Beads of different refractive indexes are not mixed into the adhesive 30 unlike the light diffusion layer 21. That is, the adhesive 30 having no diffusion function bonds the CF substrate 15 and the liquid crystal film 22. In this embodiment, the reflective electrode 2 on the TFT substrate 14 is made uneven in section to diffuse light. The uneven surface of the reflective electrode 2 randomly reflects incident light. Therefore, it is possible to dispense with the light diffusion layer 21 of the first and second embodiments, and use the adhesive 30 having no diffusion function for bonding the second polarization control element 28 and the CF substrate 15. As a result, light is not reflected by the light diffusion layer 21, so a black display quality in a reflective mode is more improved than the first embodiment as described in the first embodiment.

To make the reflective electrode 2 uneven in section, an organic film such as an acrylic resin film is formed below the reflective electrode 2. To be specific, an organic film is formed below the transparent conductive film 13 of FIG. 2. The organic film is made of a photosensitive acrylic resin to thereby easily obtain the uneven film surface through exposure and development steps. Then, the reflective electrode 2 is formed thereon to make the reflective electrode 2 uneven in section.

In this embodiment, the structure of the first polarization control element 27 and the second polarization control element 28 bonded to the transflective type liquid crystal panel may be the same as the first embodiment. The transflective type liquid crystal display device of this embodiment enables a higher display quality in a reflective mode than that of the first and second embodiments without changing the optimum black display voltage under high-humidity or -temperature conditions and lowering a contrast ratio. Further, as described in the second embodiment, the second λ/4-wave plate 29 may be used in place of the biaxial retarder 23.

### Fourth Embodiment

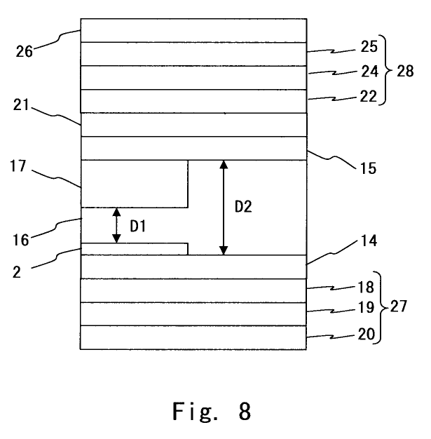

FIG. 8 is a sectional view of the structure of the transflective type liquid crystal panel according to a fourth embodiment of the present invention. The transflective type liquid crystal panel of this embodiment differs from the transflective type liquid crystal panel of the first embodiment in that the biaxial retarder 23 is omitted. In this embodiment, an NH film available from ENEOS is used as the liquid crystal film 22. The NH film is a retardation film obtained by hybrid-aligning rod-like polymer liquid crystal, that is, a viewing angle compensating plate for widening viewing angle. Further, the NH film has an in-plane phase difference of λ/4. Thus, the film itself functions as the λ/4-wave plate. Accordingly, the NH film involves a phase difference corresponding to the sum of the phase difference of the biaxial retarder 23 of the first embodiment and the phase difference of the liquid crystal film 22 of the first embodiment.

In the case of using an NH film for any existing transflective liquid crystal display device, the optimum black display voltage is changed and a contrast ratio is reduced under high-humidity or -temperature conditions due to a change in phase difference of the NH film. The NH film includes liquid crystal like the WV film. Thus, the antireflection film 26 is formed on the surface of the liquid crystal panel with the NH film to thereby prevent a contrast ratio from reducing under high-humidity or -temperature condition. That is, beneficial effects similar to those of the first embodiment are attained in this embodiment as well.

According to the above structure, the optimum black display voltage under high-humidity or -temperature conditions is not changed, and a contrast ratio is not lowered. Further, the light diffusion layer 21 is formed between the liquid crystal film 22 and the CF substrate 15 for the same reason as that of the first embodiment to thereby realize a transflective type liquid crystal display device having high display quality in a reflective mode.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A liquid crystal display device, comprising:
a transmissive region and a reflective region formed in one pixel;
a first substrate;
a second substrate provided closer to a display surface than the first substrate and opposite to the first substrate;
a liquid crystal layer formed between the first substrate and the second substrate;
a first polarization control element provided on a side opposite to the liquid crystal layer of the first substrate and including a polarizing plate and a retarder;
a second polarization control element provided on a side opposite to the liquid crystal layer of the second substrate and including a polarizing plate and a retarder, the retarder provided in the second polarization control element consists of a liquid crystal film; and
an antireflection film formed on the second polarization control element.

2. The liquid crystal display device according to claim 1, further comprising:
a light diffusion layer formed between the second substrate and the second polarization control element.

3. The liquid crystal display device according to claim 1, wherein the liquid crystal film in the second polarization control element is a retardation film obtained by hybrid-aligning liquid crystal.

4. The liquid crystal display device according to claim 2, wherein the liquid crystal film in the second polarization control element is a retardation film obtained by hybrid-aligning liquid crystal.

5. The liquid crystal display device according to claim 1, wherein at least one of the first polarization control element and the second polarization control element includes a biaxial retarder.

6. The liquid crystal display device according to claim 2, wherein at least one of the first polarization control element and the second polarization control element includes a biaxial retarder.

7. The liquid crystal display device according to claim 3, wherein at least one of the first polarization control element and the second polarization control element includes a biaxial retarder.

8. The liquid crystal display device according to claim 4, wherein at least one of the first polarization control element and the second polarization control element includes a biaxial retarder.
